(19) United States
(12) Patent Application Publication
(10) Pub. No.: US 2025/0348676 A1
(43) Pub. Date: Nov. 13, 2025

(54) CODE ENCAPSULATION MODEL FOR UNSTRUCTURED DATA ANALYSIS

(71) Applicant: Innovative Solutions Professionals, LLC, Leawood, KS (US)

(72) Inventors: James Wyly, Shawnee, KS (US); Chris Waner, Kansas City, MO (US); Jim Morgan, Overland Park, KS (US)

(21) Appl. No.: 18/660,110

(22) Filed: May 9, 2024

(51) Int. Cl. G06F 40/284; G06F 16/36; G06F 40/289

(52) U.S. Cl. CPC G06F 40/284; G06F 16/367; G06F 40/289

(57) ABSTRACT

Disclosed are techniques for automated reasoning via natural intelligence of unstructured data in order to generate meaning from unstructured data using a human-based logical reasoning framework. The disclosure provides solutions for a situation where two or more potential options are selected but where only one option is permitted. For example, the present disclosure addresses a need in medical coding where two codes are selected based on an automated reading of a medical report.

### TECHNICAL FIELD

The presently disclosed embodiments relate to code selection techniques. In particular, the presently disclosed embodiments relate to a machine learning model that selects one of a plurality of codes based on a logical inference.

### BACKGROUND

Machine learning (ML) for natural language processing (NLP) and text analytics involves using machine learning algorithms and/or artificial intelligence (AI) models to understand the meaning of text documents. These documents can be just about anything that contains text: medical reports, social media comments, online reviews, survey responses, and even financial, medical, legal, and/or regulatory documents. In essence, the role of machine learning and AI in NLP and text analytics is to accelerate and automate the underlying text analytics functions and NLP features that turn unstructured text into useable data and insights.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example report with unstructured text in accordance with an example embodiment.

FIG. 2 illustrates an example flow diagram of an automated reasoning via natural intelligence (ARNI) system in accordance with an example embodiment.

FIG. 3 illustrates an example method for automated reasoning via natural intelligence in accordance with an example embodiment.

FIG. 4 illustrates report node creations within the ARNI system in accordance with an example embodiment.

FIG. 5 illustrates the creation of sentence nodes within the ARNI system in accordance with an example embodiment.

FIG. 6 illustrates tokenization within the ARNI system in accordance with an example embodiment.

FIG. 7 illustrates connecting archetypes to sentences within the ARNI system in accordance with an example embodiment.

FIG. 8 illustrates connecting archetypes through microgrammatical analysis within the ARNI system in accordance with an example embodiment.

FIG. 9 illustrates creating logics nodes within the ARNI system in accordance with an example embodiment.

FIG. 10 illustrates the creation of summary nodes based on the logics nodes within the ARNI system in accordance with an example embodiment.

FIG. 11 illustrates a transverse Tree of Operational Requirement (TOOR) to determine requirement satisfaction within the ARNI system in accordance with an example embodiment.

FIG. 12 illustrates code selection within the ARNI system in accordance with an example embodiment.

FIGS. 13A-13D illustrate subgraphs analyzing nodes on a static knowledge graph for total encapsulation according to some aspects of the present disclosure.

FIGS. 14A-14D illustrate subgraphs analyzing nodes on a static knowledge graph for partial encapsulation according to some aspects of the present disclosure.

FIGS. 15A-15D illustrate subgraphs analyzing nodes on a static knowledge graph for isolated encapsulation according to some aspects of the present disclosure.

FIGS. 16A-16C illustrates a subgraph analyzing nodes on a static knowledge graph for another isolated encapsulation according to some aspects of the present disclosure.

FIGS. 17A-17D illustrate subgraphs analyzing nodes on a static knowledge graph for sibling encapsulation according to some aspects of the present disclosure.

FIGS. 18A-18C illustrate subgraphs analyzing nodes on a static knowledge graph for another sibling encapsulation according to some aspects of the present disclosure.

FIGS. 19A-19C illustrate subgraphs analyzing nodes on a static knowledge graph for ad hoc encapsulation according to some aspects of the present disclosure.

FIG. 20 is a flow chart according to some aspects of the present disclosure.

FIG. 21 illustrates an example of a computing system, according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### OVERVIEW

Some solutions have been generated for better analyzing text-based data and determining a meaning for that data based on an induction heuristic. For example, U.S. patent application Ser. No. 18/366,853 titled Holistic Logical Inference Model for Unstructured Data Analysis, the contents of which are hereby incorporated by reference in their entirety, describes a system referred to as “ARNI” (automated reasoning via natural intelligence). ARNI analyzes unstructured text by applying an induction heuristic to determine the meaning behind the unstructured text. However, ARNI can sometimes select two or more possible meanings for the text, only one of which can be selected. For example, in the medical coding space, ARNI can sometimes select two codes corresponding to the same medical report, but where only one code can be used.

The present disclosure is directed to techniques for automated reasoning via natural intelligence of unstructured data in order to generate meaning from unstructured data using a human-based logical reasoning framework. The disclosure provides solutions for a situation where two or more potential options are selected but where only one option is permitted. For example, the present disclosure addresses a need in medical coding where two codes are selected based on an automated reading of a medical report.

In one aspect, a method includes receiving unstructured data including text, applying contextual analysis and phrase recognition to at least a portion of the unstructured data, breaking the unstructured data into tokens based on the step of applying, determining archetype associations of the tokens, applying a logics operation to determine a code conclusion from the archetype associations, wherein the code conclusion includes a plurality of selections, querying a knowledge graph for encapsulation data describing a process for determining which of the plurality of selections to select, and encapsulating a single selection and excluding a remainder of the selections of the plurality of selections based on the process provided by the knowledge graph.

In another aspect, the method includes writing metadata relationships between the selection and the unstructured data.

In another aspect, the method includes writing metadata relationships between the unstructured data and an excludes node on the knowledge graph.

In another aspect, the method includes wherein the single selection is not among the plurality of selections, and the excluding excludes each of the plurality of selections.

In another aspect, the method includes wherein the single selection is among the plurality of selections output from the logical inference model, and the remainder of the selections include all of the plurality of selections except for the single selection.

In another aspect, the method includes wherein the plurality of selections are medical codes that differ only at a final alphanumeric position, and wherein the step of choosing chooses the selection with a highest alphabetical letter as compared to a remainder of the plurality of selections.

In another aspect, the method includes wherein the step of choosing a single selection includes textually analyzing the plurality of selections.

In another aspect, a computing apparatus includes a processor and a memory storing instructions that, when executed by the processor, configure the apparatus to perform the following steps: receiving unstructured data including text, applying contextual analysis and phrase recognition to at least a portion of the unstructured data, breaking the unstructured data into tokens based on the step of applying, determining archetype associations of the tokens, applying a logics operation to determine a code conclusion from the archetype associations, wherein the code conclusion includes a plurality of selections, querying a knowledge graph for encapsulation data describing a process for determining which of the plurality of selections to select, and encapsulating a single selection and excluding a remainder of the selections of the plurality of selections based on the process provided by the knowledge graph.

In another aspect, the instructions further configure the apparatus to perform writing metadata relationships between the selection and the unstructured data.

In another aspect, the instructions further configure the apparatus to perform writing metadata relationships between the unstructured data and an excludes node on the knowledge graph.

In another aspect, the single selection is not among the plurality of selections, and the excluding excludes each of the plurality of selections.

In another aspect, the single selection is among the plurality of selections output from the logical inference model, and the remainder of the selections include all of the plurality of selections except for the single selection.

In another aspect, the plurality of selections are medical codes that differ only at a final alphanumeric position, and wherein the step of choosing chooses the selection with a highest alphabetical letter as compared to a remainder of the plurality of selections.

In another aspect, the computing apparatus includes wherein the step of choosing a single selection includes textually analyzing the plurality of selections.

In another aspect, a non-transitory computer-readable storage medium includes instructions that when executed by a computer, cause the computer to perform the following steps: receiving unstructured data including text, applying contextual analysis and phrase recognition to at least a portion of the unstructured data, breaking the unstructured data into tokens based on the step of applying, determining archetype associations of the tokens, applying a logics operation to determine a code conclusion from the archetype associations, wherein the code conclusion includes a plurality of selections, querying a knowledge graph for encapsulation data describing a process for determining which of the plurality of selections to select, and encapsulating a single selection and excluding a remainder of the selections of the plurality of selections based on the process provided by the knowledge graph.

In another aspect, the instructions further configure the computer to perform writing metadata relationships between the selection and the unstructured data.

In another aspect, the instructions further configure the computer to perform writing metadata relationships between the unstructured data and an excludes node on the knowledge graph.

In another aspect, the single selection is not among the plurality of selections, and the excluding excludes each of the plurality of selections.

In another aspect, the plurality of selections are medical codes that differ only at a final alphanumeric position, and wherein the step of choosing chooses the selection with a highest alphabetical letter as compared to a remainder of the plurality of selections.

In another aspect, the step of choosing a single selection includes textually analyzing the plurality of selections.

### DESCRIPTION OF EXAMPLE EMBODIMENTS

The analysis of human language within the mind to generate understanding and meaning is complex: such as whether human language is based on logic, whether logic is based on language, or whether both language and logic are based on imagery. The content of language can express concrete images, for example, that is directly related to specific actions. However, the syntax and function of the same content words can also express a large amount of complex logic: possibility, necessity, tenses, indexicals, conditionals, causality, quotations, metalanguage about the language itself, etc.

The reasoning abilities of even the most simplistic of language use, such as language spoken by children, have challenged the syntax-based theories of logic and linguistics on which ML and AI models have been built. For instance, the semantic aspects of imagery, action, and feelings appear to be more important than syntax in most instances. A distinctive feature of human brains, for example, is the ability to create neural maps. In addition to the creation of maps, brains are also creating images (the main currency of human minds). Ultimately, consciousness as expressed by language allows one to experience maps as images, to manipulate those images, and to apply reasoning to them.

The maps and images within a human mind form mental models of the real world or of imaginary worlds in each person's hopes, fears, plans, and desires are expressed. They provide a “model theoretic” semantics for language that uses perception and action for testing models against reality. They can define the criteria for truth, but they are also flexible, dynamic, and situated in the daily drama of life. It stands to reason that all human reasoning is based on a concrete, but possibly changing, mental image that may be aided by a model constructed by the mind. Determining meaning in any analytical framework must take into account these nuances and complexities of human expressions.

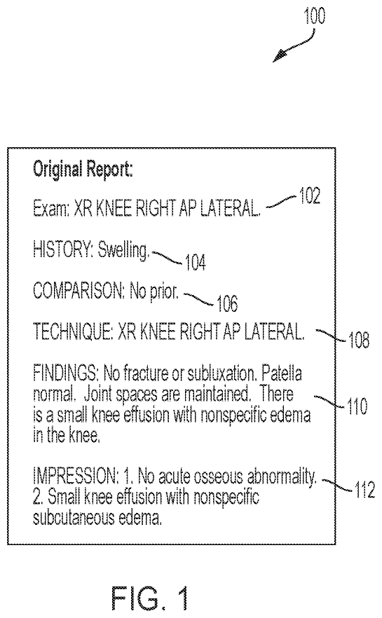

Take, for example, FIG. 1, which illustrates an example medical report 100 with unstructured text in accordance with an example embodiment. While an example medical report is shown in this particular example embodiment, any document (physical or digital) and/or data source with unstructured text is contemplated by alternative embodiments. These documents, for example, can be just about anything that contains text including, but not limited to: medical reports, social media comments, online reviews, survey responses, and even financial, medical, legal, and/or regulatory documents.

In FIG. 1, the medical report 100 contains unstructured text related to a type of medical examination 102—in this case, an “XR KNEE RIGHT AP LATERAL” type of medical examination. More information is noted by the examining professional-such as history 104 of the event causing the medical examination type (e.g., “Swelling”), comparison 106 to previous events (e.g., “No prior”), the technique 108 used by the examining professional (e.g., “XR KNEE RIGHT AP LATERAL”), the findings 110 (e.g., “No fracture or subluxation. Patella normal. Joint spaces are maintained. There is a small knee effusion with nonspecific edema in the knee”), and other impressions 112 (e.g., “1. No acute osseous abnormality. 2. Small knee effusion with nonspecific subcutaneous edema”).

In order to understand the content of the medical report 100, the analytical framework must go beyond the abilities of machine learning and AI in NLP, which is limited to specific word choice that form patterns within large datasets, and which completely misses the complexities needed to fully understand the nuanced meaning within the medical report 100 that's not directly expressed, indirectly expressed, and/or expressed in a unique manner to the examining professional. One or more models that are analogous to visualization for discovering a proof or logical conclusion is needed, such as visualization techniques centered around graph notations that use visual methods in the proof itself. For example, relational graphs and existential graphs (EGs) (using nested ovals to represent scope) can be methods by which diagrammatic logic can be implemented. The logic-based methods of induction, abduction, and deduction are based on the same kinds of analogies used in observation and imagination. These ideas in combination with existential graphs not only have a simpler mapping to and from language and imagery, they also have a direct mapping to simpler rules of inference with an elegant version of model theory with which to analyze language. Some applications of this idea can be ephemeral and/or static knowledge graphs, as will be discussed further herein.

An accurate analysis of the nuances of human understanding and interpretation of the language within the medical report 100 is needed. For the example embodiment shown, physicians are paid by applying the correct numeric code for the treatment provided. The process of transforming treatment detail into billable codes is known as Medical Coding. However, multiple problems arise within Medical Coding that need more nuanced text analysis than machine learning, AI, or NLP techniques. For example, the text within the medical report 100 may contain content that has subjective accuracy, meaning that any two experts may have differing opinions on the proper procedure codes. Moreover, assigning the proper procedure codes can be labor intensive, requiring continuous education and training. High human error rates are common, based on one or more of subjective accuracy, mis-coding, and/or typos. While Computer Assisted Coding (CaC) attempts to map medical text to a list of possible codes, CaC fails for the more nuanced cases requiring subjective accuracy and/or cases of mis-coding or typos. Offshore coding can be cost effective for non-complex medical procedures, but offshore systems suffer from higher error rates and data security concerns. These same types of issues span across all manner of text that must be analyzed accurately and quickly.

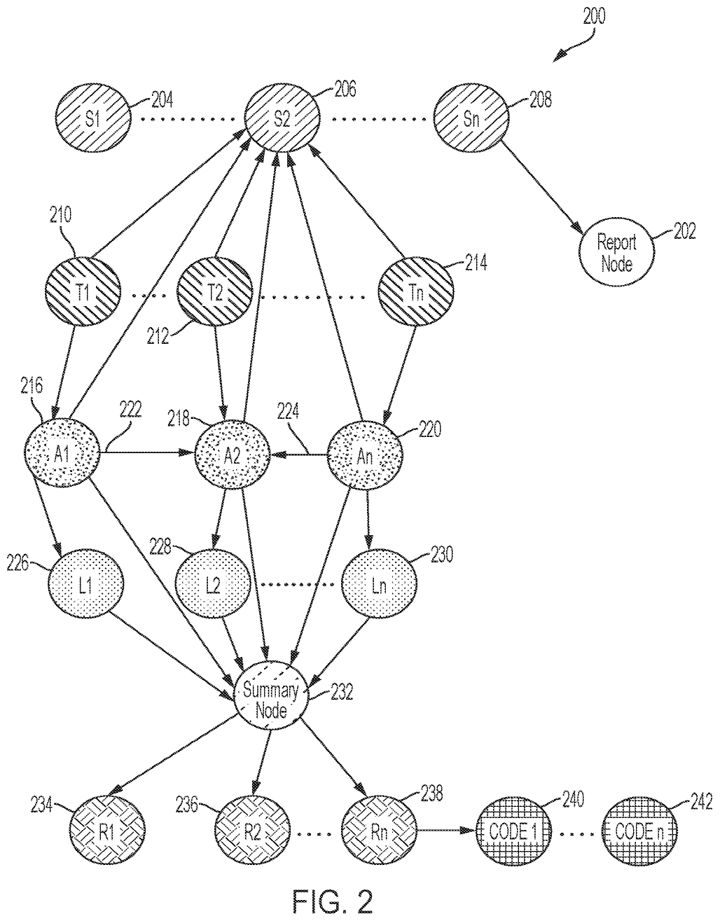

As a result, the systems and methods disclosed herein describe techniques the medical report 100 is analyzed using a holistic logical inference model. FIG. 2, for example, illustrates an example flow diagram of an automated reasoning via natural intelligence (ARNI) system 200 in accordance with one or more example embodiments.

The ARNI system 200 analyzes unstructured data using a holistic logical inference model. According to some example embodiments, the ARNI system can receive unstructured data, which may include text, and then apply a logical inference model to at least one or more portions of the unstructured data, such as a logical inference model that applies an induction heuristic model to the one or more portions of the unstructured data to generate a meaning to the at least one or more portions of the unstructured data. For instance, the ARNI system 200 can be a modal graph-based domain specific language processor, which can combine induction heuristics with deductive techniques to deduce the content and meaning of language.

For example, in the example embodiment shown, a portion or all of the text within the unstructured data, such as text in medical report 100 of FIG. 1, can be assigned to a labelled section, such as sections 102-112 of the medical report 100. One labelled section, a portion of the labelled sections, and/or all of the labelled sections can be attached to a Report Node 202 within a knowledge graph 200. The knowledge graph 200 can create sentence nodes based on the labelled sections within the Report Node 202. For example, each labelled section can be broken into one or more sentences and attached to sentence node S1 204, sentence node S2 206 . . . sentence node Sn 208 within the knowledge graph 200.

Each sentence can then be further broken down into one or more tokens in a tokenization process, such as breaking sentence node S2 206 into token node T1 210, token node T2 212 . . . token node Tn 214. For example, tokens may be words and/or punctuation which have an ordered position within each sentence node. Tokens can include, for example, the part of speech it belongs to, its plural state, characterization of its type within language, whether it has static meaning within language, etc. In some embodiments, the Report Node 202, sentence nodes S1 204 . . . . Sn 208, and/or the token nodes T1 210 . . . . Tn 214 preserves ordered position within the knowledge graph 200. As will be disclosed further herein, the tokens determined by the knowledge graph 200 may include unitary tokens and/or compound tokens based on ontological static data in memory.

In the example embodiment shown, one or more archetypes are connected to sentences. For example, the one or more tokens (e.g., token nodes T1 210 . . . . Tn 214) and/or the sentences (e.g., sentence nodes S1 204 . . . . Sn 208) can be associated with one or more archetypes. The archetype can include, but is not limited to: a name, ontology, ontology type, descriptive characteristics (e.g., type of, part of, structural component of a body), systems the archetype belongs to, taxonomical region, affect, medical classification, etc. The archetype can be a typical example of a person or object; a recurrent symbol, theme, or motif within the medical report 100, and/or distinctive imagery or visualization in which a logical framework can be built. In some embodiments, one or more archetypes within the associations can be inferred by one or more logical inference models.

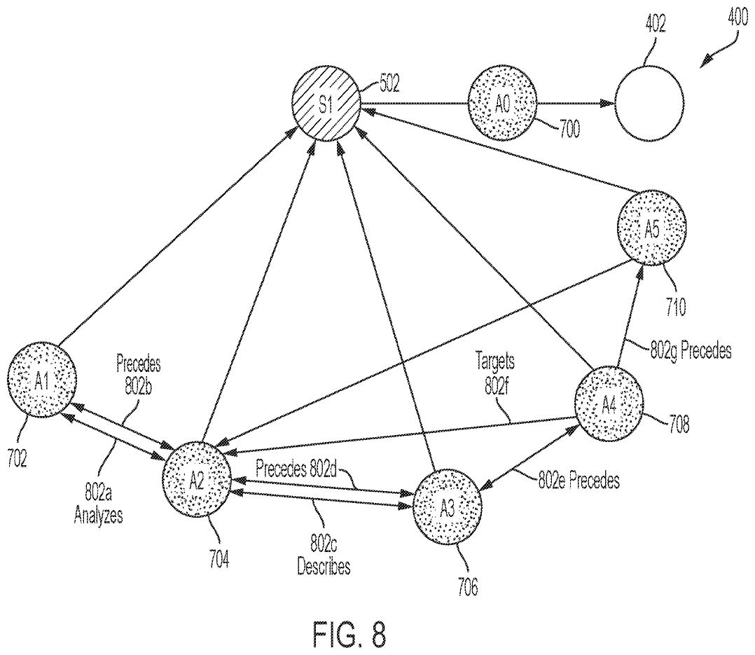

In knowledge graph 200, for instance, archetype node A1 216 is associated with token node T1 210 and sentence node S2 206; archetype node A2 218 is associated with token node T2 212 and sentence node S2 206; and archetype node An 220 is associated with token node Tn 214 and sentence node S2 206. In some embodiments, each archetype can be associated with another archetype, such as archetype node A1 being associated (222) with archetype node A2 218, and archetype node An 220 being associated (224) with archetype node A2 218. In some embodiments, microgrammars can be used to connect archetypes (discussed in more detail herein in FIG. 8).

In some embodiments, an ephemeral logics graph can be created based on connections between one or more ontological logic nodes, each logic node associated with at least one archetype node (although any number of archetype nodes can be associated with each logic node). For example, in knowledge graph 200, logic node L1 226 is associated with archetype node A1 216, logic node L2 228 is associated with archetype node A2 218, and logic node Ln 230 is associated with archetype node An 220. In some embodiments, one or more of the logical inference models can solve syllogisms applied to the text by setting inclusion or exclusion properties on archetypal relationships to the ontological logic nodes.

A summary node 232 can utilize the logics nodes (e.g., logic node L1 226, logic node L2 228, and/or logic node Ln 230) and/or the archetype nodes (e.g., archetype node A1 216, archetype node A2 218, and/or archetype node An 220) to generate a summary of all or a portion of the analyzed information from the unstructured text of medical report 100. In some embodiments, the summary node 232 can determine and/or analyze the dimensions of the information related to the unstructured text, and synthesize a new statement of fact. In some instances, the new statement of fact may be more specific in all or a portion of the variable dimensions than any single instance of the concept within the medical report 100.

In some embodiments, the knowledge graph 200 may determine if one or more requirement logics operations are satisfied within the summary node 232. For example, the knowledge graph 200 can determine whether pathways are valid based on whether the output from the summary node 232 satisfies the conditions specified by requirements node R1 234, requirements node R2 236, and requirements node Rn 238. Once all or a threshold number of requirements nodes are verified by the knowledge graph 200 to have valid pathways, one or more codes can be assigned to its respective portion of the text. For example, one portion of the text from the medical report 100 is assigned to code 1 240, and another portion of the text from the medical report 100 is assigned to code n 242. In some embodiments, a portion of the text can span one or more codes. These codes can then be output into any form by which medical coding is used within the medical healthcare system.

While the current embodiment has been discussed in relation to a medical document and medical coding, the knowledge graph 200 creation and utilization can be applied to any use for which text is analyzed. The knowledge graph 200 as described is a holistic logical inference technique which is designed to mimic human comprehension. Therefore, the knowledge graph 200 can be applied to just about anything that contains text: medical reports, social media comments, online reviews, survey responses, and even financial, medical, legal, and/or regulatory documents. The knowledge graph 200 can, using the methods and techniques described herein, turn that unstructured text into usable data and insights.

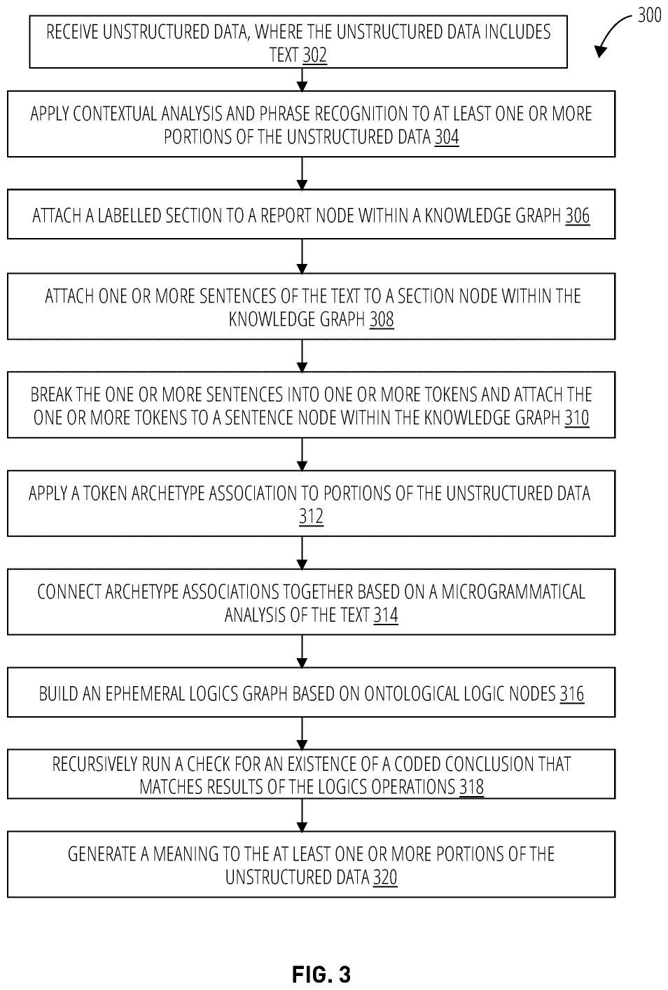

FIG. 3 illustrates an example routine 300 for automated reasoning via natural intelligence (ARNI) in accordance with an example embodiment. Although the example routine 300 depicts a particular sequence of operations, the sequence may be altered without departing from the scope of the present disclosure. For example, some of the operations depicted may be performed in parallel or in a different sequence that does not materially affect the function of routine 300. In other examples, different components of an example device or system that implements the routine 300 may perform functions at substantially the same time or in a specific sequence.

In block 302, routine 300 for a holistic logical inference model receives unstructured data. For example, the unstructured data can include text, images, and/or other representations of language. In block 304, routine 300 applies contextual analysis and phrase recognition to the at least one or more portions of the unstructured data. In some embodiments, based on the contextual analysis and the phrase recognition, one or more logical inference models are applied to the unstructured data that combines the induction heuristic model with at least one deductive technique to generate at least one meaning to the at least one or more portions of the unstructured data. The logical inference model can, for example, mimic human logical reasoning applied to the unstructured data through the use of ephemeral knowledge graphs such as the described in FIG. 1 and FIGS. 4-12.

Routine 300 can further assign a portion of text within the unstructured data to a labelled section and attach the labelled section to a report node within the knowledge graph in block 306. In block 308, the portion of the text is broken further into one or more sentences and the one or more sentences are then attached to at least one section node within the knowledge graph.

Tokenization can then occur for routine 300. The one or more sentences are broken into one or more tokens and the one or more tokens are attached to a sentence node within the knowledge graph in block 310. In some embodiments, the report node, the section node, and/or the sentence node preserves ordered position within the knowledge graph. In some embodiments, tokens can be unitary or compound. For example, compound tokens can be recognized from among unitary tokens by cross-referencing ontological static data in memory.

In block 312, an archetype can be associated with one or more tokens, based on determining that a portion of the unstructured data matches the archetype. Archetypes can be explicitly defined or can be inferred by logical inference model(s). In some embodiments, the archetype can span multiple types of token archetype characteristics, such as unitary or compound. For example, routine 300 can apply a unitary token archetype association to portions of the unstructured data for unitary tokens, and/or apply a compound archetype association to the portions of the unstructured data for compound tokens. In some embodiments, any number of archetype associations can be connected together based on a microgrammatical analysis of the text in block 314. For example, the microgrammatical analysis of the text can be based on one or more of a phrase or sentence proximity within the unstructured data. In some embodiments, an ephemeral knowledge graph of the unstructured data can be built based on the connection of these archetype associations.

Additionally and/or alternatively, in block 316 the ephemeral knowledge graph can be created and/or built from the creation of ontological logic nodes. For example, the logical inference model(s) can be applied to solve syllogisms applied to the text by setting inclusion or exclusion properties on archetypal relationships to the ontological logic nodes. Routine 300 can determine valid pathways through the knowledge graph based on a comparison between nodes of the ephemeral knowledge graph and summary graphs of a report. Requirement logics operations can be performed on returned transversal pathways, and a check can be recursively run for an existence of a coded conclusion for the returned transversal pathways in block 318. Routine 300 can run the recursive check until a coded conclusion has been reached or no transversal pathway matches results of the logics operations. Once a coded conclusion has been reached by the recursive check, a code can be assigned to a portion of the text. This code, or other means of generating meaning from the text, is a foundation for assigning meaning to at least one or more portions of the unstructured data in block 320.

In some embodiments, the ephemeral knowledge graph for which the ARNI system is based can be a modal graph-based domain specific language processor, which can combine induction heuristics with deductive techniques to deduce the content and meaning of language. These techniques can inform the creation of ontological logic nodes, the logical inference model(s) applied, and/or the requirement logics operations. For example, the ARNI system can implement modal logic, in which an expression (like “necessarily” or “possibly”) is used to qualify the truth of a judgement. Modal logic can be, for example, the study of the deductive behavior of the expressions “it is necessary that” and “it is possible that”. However, the term ‘modal logic’ may be used more broadly for a family of related systems. These include logics for belief, for tense and other temporal expressions, for the deontic (moral) expressions such as “it is obligatory that” and “it is permitted that”, and many others. An understanding of modal logic is particularly valuable in the formal analysis of expressions relating to philosophical argument, where expressions from the modal family are both common and confusing. Other logic systems that can be implemented within the ARNI system can include temporal logic (e.g., “it will always be the case that”, “it will be the case that”, “it has always been the case that”, “it was the case that”, etc.), doxastic logic (e.g., “xx believes that”, and/or epistemic logic (e.g., “xx knows that”, etc.), etc. The unstructured text or data can be analyzed based on the various logical expression types for their necessitation rules, distribution axioms, interaction axioms, etc. to determine symmetries/asymmetrics between possible logical conclusions to be drawn from the text or data. The ARNI system may use one or a combination of multiple logical expression types, such as by determining correspondence between axioms and conditions between the multiple logical expression types.

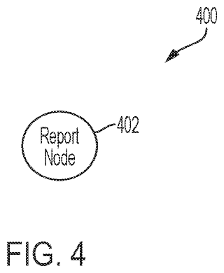

FIGS. 4-12 illustrate example embodiments from analyzing a document (e.g., medical report 100) in FIG. 1. While the following figures are discussed in relation to a medical document and medical coding, ephemeral knowledge graph creation and utilization can be applied to any use for which text is analyzed (e.g., anything that contains text, such as, but not limited to: medical reports, social media comments, online reviews, survey responses, and even financial, medical, legal, and/or regulatory documents). Using the methods and techniques described herein, any unstructured text can be turned into useable data and insights.

FIG. 4 illustrates report node creations within an automated reasoning via natural intelligence (ARNI) system 400 in accordance with an example embodiment. The ARNI system 400 mimics human comprehension through a holistic logical inference model. The ARNI system 400 can assign report text to the text property of a report node. In the shown example embodiment, the ARNI system 400 has taken in the medical report 100 of FIG. 1 with unstructured text. The portions of the text are assigned to one or more labelled sections, and the labelled sections 102-112 are attached to report node 402. For example, labelled sections 102-112 are associated with a tag of “report text” in report node 402, marking the medical report 100 as report text (rather than another type of text—e.g., social media comments, online reviews, survey responses, etc.). In some embodiments, report node 402 preserves the ordered position of the labelled sections 102-112 within the knowledge graph of the ARNI system 400.

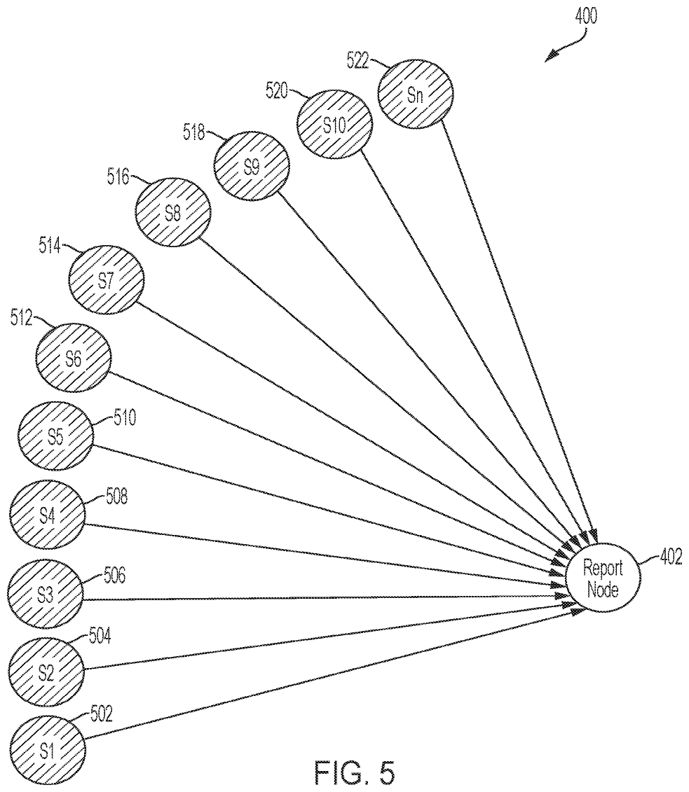

FIG. 5 illustrates the creation of sentence nodes within the ARNI system 400 in accordance with an example embodiment applied to the medical report 100. The ARNI system 400 can break portions of the text from the medical report 100 into one or more sentences and then attach the one or more sentences to a section node within an ephemeral knowledge graph.

For example, sentence node S1 502 isolates the text in labelled section 102 (e.g., “Exam: XR KNEE RIGHT AP LATERAL”), and determines what purpose the sentence is used for. In this case, sentence node S1 502 is created within the knowledge graph signifying the text section is “exam”, and can additionally and/or alternatively include the text in the labelled section 102 and/or its position (e.g., position: 1) in the medical report 100.

Similarly, sentence node S2 502 is created from another portion of text within the report node 402-labelled section 104—and determines that the sentence/text “swelling” is used for “indications”. Its position is assigned as (position: 2). Sentence node S3 506 is created from labelled section 106 and determines that the sentence/text “no prior” is used for “comparison”. Sentence node S4 508 is created from labelled section 108 and determines that the sentence/text “XR KNEE RIGHT AP LATERAL” is used for “technique”. Sentence node S5 510 is created from labelled section 110 and determines that the sentence/text “No fracture or subluxation” is used for “findings”.

Each labelled section can also be broken into its individual sentences. For example, sentence node S6 512 is created from labelled section 110 and determines that the sentence/text “Patella normal” is used for “findings”. Sentence node S7 514 is created from labelled section 110 and determines that the sentence/text “Joint spaces are maintained” is used for “findings”. Sentence node S8 516 is created from labelled section 110 and determines that the sentence/text “There is a small knee effusion with nonspecific edema in the knee” is used for “findings”. Similarly, sentence node S9 518 is created from labelled section 112 and determines that the sentence/text “1. No acute osseous abnormality” is used for “impressions”. Sentence node S10 520 is created from labelled section 112 and determines that the sentence/text “2. Small knee effusion with nonspecific subcutaneous edema” is used for “impressions”. Sentence node Sn 522 can be created from any other labelled section, if found, to determine what a sentence/text is used for.

In some embodiments, a portion or all of the sentence nodes preserve ordered position within the knowledge graph. For example, sentence node S1 502 has (position: 1) and sentence node S2 504 has (position: 2), and so on.

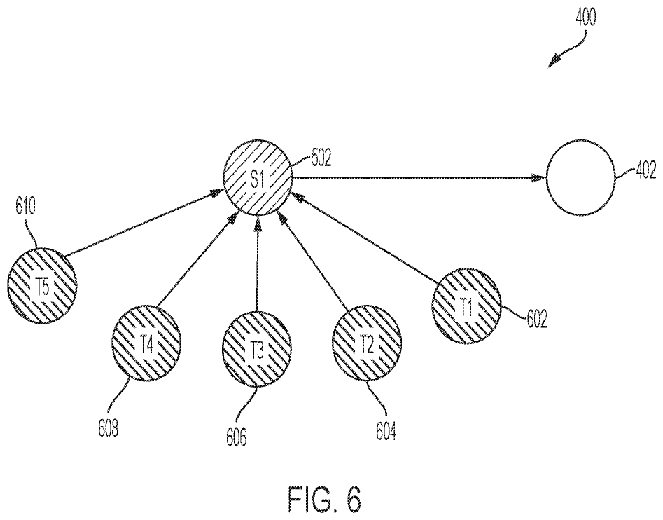

FIG. 6 illustrates tokenization within the ARNI system 400 in accordance with an example embodiment. Each sentence can be broken down into one or more tokens within the knowledge graph. For example, sentence node S1 502, which corresponds to “section: exam” with text “XR KNEE RIGHT AP LATERAL” in ordered position (position: 1) with the report text in report node 402, can be broken down into token node T1 602, token node T2 604, token node T3 606, token node T4 608, and token node T5 610.

For example, the ARNI system 400 can isolate “xr” within the text and create token node T5 610. Each token can be associated with a part of speech, its plurality state (singular vs plural), static meaning (true or false), token association name, and token type (unitary vs compound). In this example embodiment, token node T5 610 can be assigned as “xr” with part of speech: noun; plurality: singular; static: true; token: xr; and type: unitary. This token node, like all others within the ARNI system 400, can include flags or information that links the token node to its report node(s) (e.g., report node 402).

The rest of the text “XR KNEE RIGHT AP LATERAL” within sentence node S1 502 can be isolated and analyzed in the same way. Token node T4 608 can be assigned as “knee” with part of speech: noun; plurality: singular; static: true; token: knee; and type: unitary. Token node T3 606 can be assigned as “right” with part of speech: noun; plurality: singular; static: true; token: right; and type: unitary. Token node T2 604 can be assigned as “ap” with part of speech: noun; plurality: singular; static: true; token: ap; and type: unitary. Token node T1 602 can be assigned as “lateral” with part of speech: noun; plurality: singular; static: true; token: lateral; and type: unitary. And so on until the entire sentence within sentence node S1 502 has been assigned at least one token node.

In some embodiments, a portion or all of the token nodes preserve ordered position within the knowledge graph. For example, token node T5 610 has (position: 1) and token node T4 608 has (position: 2), and so on.

Additionally and/or alternatively, the token nodes can correspond to different types of tokens with varying characteristics. For example, token nodes can correspond to unitary and/or compound tokens. In some embodiments, compound tokens can be recognized from among unitary tokens within the one or more tokens by cross referencing ontological static data in memory (e.g., a preexisting graph engine with previously defined and/or created tokens).

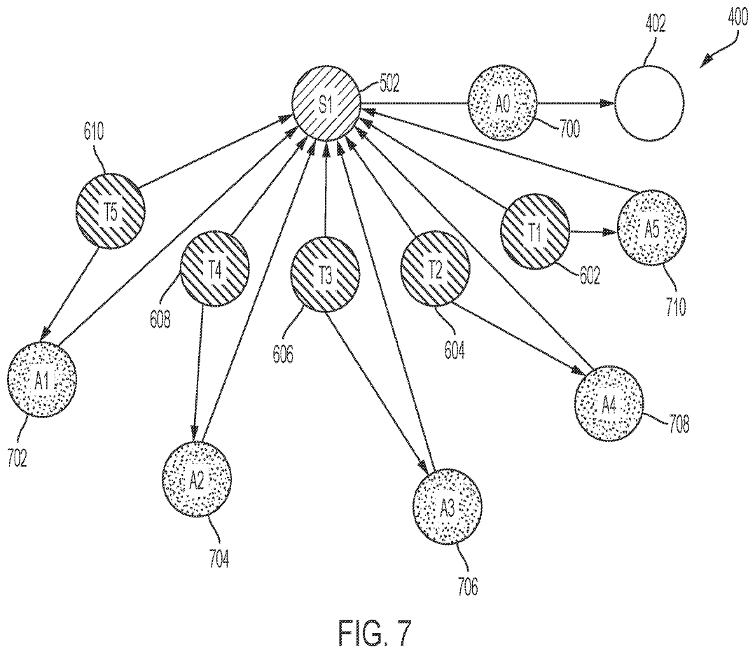

FIG. 7 illustrates connecting archetypes to sentences within the ARNI system in accordance with an example embodiment. One or more archetypes can be attached or associated with each token. The archetype can include, but is not limited to: a name, ontology, ontology type, descriptive characteristics (e.g., type of, part of, structural component of a body), systems the archetype belongs to, taxonomical region, affect, medical classification, etc. The archetype can be a typical example of a person or object; a recurrent symbol, theme, or motif within the medical report 100, and/or distinctive imagery or visualization in which a logical framework can be built. In some embodiments, one or more archetypes within the associations can be inferred by one or more logical inference models.

In the example embodiment shown, archetype node A1 702 corresponds to the “x-ray” archetype, which is associated with token node T5 610 and sentence node S1 502. Each archetype can have characteristics that define it and link it to other nodes within the ephemeral knowledge graph, such as its affect, ontology characteristic(s), ontology type, structure, location within the body, the system of the body it belongs to, the medical service that covers it, etc. For example, archetype node A1 702 “x-ray” is defined by characteristics: affect: human body; hierarchically catalogued: true; name: x-ray; ontology: Radiological Service; ontology type: concrete; static: true; taxonomy: null; and type of: plain radiography. Additionally and/or alternatively, archetype node A1 702 “x-ray” can be associated with sentence node S1 502 based on the following characteristics: ontology: Radiological Service; phrase number: 1; position: 1, source token node: token node T5 610, token position: 1; type: sentence.

Furthermore, archetype node A2 704 corresponds to the “knee” archetype, which is associated with token node T4 608 and sentence node S1 502. Archetype node A2 704 is defined by characteristics: hierarchically cataloged: true; name: knee; ontology: Anatomy; ontology type: concrete; static: true; type of: lower joint, major joint; part of: lower leg; structure: joint; structure category: member; system: musculoskeletal system; and taxonomical region: lower extremity. Additionally and/or alternatively, archetype node A1 704 “knee” can be associated with sentence node S1 502 based on position: 2.

Archetype node A3 706 corresponds to the “right” archetype, which is associated with token node T3 606 and sentence node S1 502. Archetype node A3 706 is defined by characteristics: hierarchically cataloged: true; name: right; ontology: Spatial; ontology type: concrete; and static: true.

Archetype node A4 708 corresponds to the “anteroposterior” archetype, which is associated with token node T2 604 and sentence node S1 502. Archetype node A4 708 is defined by characteristics: hierarchically cataloged: true; name: anteroposterior; ontology: Views; ontology type: concrete; and static: true.

Other archetype nodes may have more or less characteristics to define it, and/or may be attached to a sentence node rather than a token node. For example, archetype node A5 710 corresponds to the “lateral” archetype, which is associated with token node T1 602 and sentence node S1 502. In contrast, archetype node A0 700 is associated only with sentence node S1 502. Both archetype node A5 710 and archetype node A0 700 can be defined by the characteristics: hierarchically cataloged: true; name: lateral; ontology: Views; ontology type: concrete; and static: true.

Additionally and/or alternatively, archetypes can be unitary or compound depending on the token it is applied to. For example, a unitary token archetype association can be applied to portions of the unstructured data for unitary tokens, and a compound archetype association can be applied to the portions of the unstructured data for compound tokens. Compound tokens can be recognized from tokens unitary tokens by cross-referencing the corresponding ontological static data in memory (e.g., a preexisting graph engine).

Archetypes can the creation of the archetype nodes can span any characteristic that provides categorization, meaning, or insight into the analyzed text. For example, the ARNI system 400 can associate body parts with human anatomical regions by cross-referencing the ontological static data within a graph engine. These human anatomical regions can be attached to the appropriate portion(s) of each sentence. The ARNI system 400 can recognize token operators and attach operator archetypes to the appropriate portion(s) of each sentence. Token functions can be recognized, and function archetypes can be attached to the appropriate portion(s) of each sentence. The ARNI system 400 can recognize token punctuations and attach punctuation archetypes to the appropriate portion(s) of each sentence.

In some embodiments, the ARNI system 400 can use substring analysis to recognize when a token ends with a plural suffix and is a recognized entity without the suffix. The ARNI system 400 can then use the part of speech to narrow the likelihood of misunderstanding plural suffixes. The substring analysis and part of speech cues from ontological static data from the graph engine can then be used to solve plural noun variations within the text. Substring analysis can moreover be used to recognize unidentified tokens by their Greck or Latin roots to auto-categorize their ontology. This allows for each token to be assigned to its appropriate archetype node(s).

Other archetypes can be associated with one or more tokens based on substring analysis identifying adjectives, unilateral or bilateral archetypal characteristics, gendered terms, regulatory terms and ontologies, anatomy, rationale, contrast, service type (e.g., Radiological Service, IR Service, etc.), ephemeral date/time archetypes, ephemeral numerical value archetypes, etc.

FIG. 8 illustrates connecting archetypes through microgrammatical analysis within the ARNI system 400 in accordance with an example embodiment. One or more of archetype associations can be connected together based on a microgrammatical analysis of the text, where in some embodiments the microgrammatical analysis of the text is based on a phrase, sentence proximity, etc. This builds an ephemeral knowledge graph of the unstructured data based on the connection of the various archetype associations.

In the example embodiment shown, the “x-ray” archetype A1 702 is connected to the “knee” archetype A2 704 because archetype A1 702 “analyzes” 802a and “precedes” 802b archetype A2 704. The “knee” archetype A2 704 is connected to the “right” archetype A3 706 because archetype A2 704 “describes” 802c and “precedes” 802d archetype A3 706. The “right” archetype A3 706 is connected to the “anteroposterior” archetype A4 708 because archetype A3 706 “precedes” 802e archetype A4 708.

Archetypes may also be connected to more than one other archetype based on the microgrammatical analysis. For example, the “anteroposterior” archetype A4 708 is connected to the “knee” archetype A2 704 and the “lateral” archetypes A5 710 because archetype A4 708 “targets” 802f archetype A2 707, while archetype A4 708 “precedes” 802g archetype A5 710.

In some embodiments, microgrammatical analysis of the text can analyze and set archetype positions. For example, the ARNI system 400 can solve the difference between unitary and compound token positions and assign common denominator(s) to the archetype position(s). The ARNI system 400 can create links between archetypes that store the relative position of an archetype to another archetype. Function and operator connections can be reduced where the source token is NULL. In some embodiments, the ARNI system 400 can perform phrase recognition and/or identify sentence inflectors (e.g., alethic mood, deontic mood, temporal mood, ambiguous mood, affirmations and negations (polarities)), etc. Inflectors can be associated to archetypes by creating inflection relationships between inflectors and archetypes through micro grammatical analysis. For example, impossible inflections can be removed, the ARNI system 400 can determine if inflectors inflect upon the subject/object of the sentence or whether the inflectors inflect forward or backward through the sentence in active or passive voice. This information allows the ARNI system 400 to connect the various archetypes within the ephemeral knowledge graph.

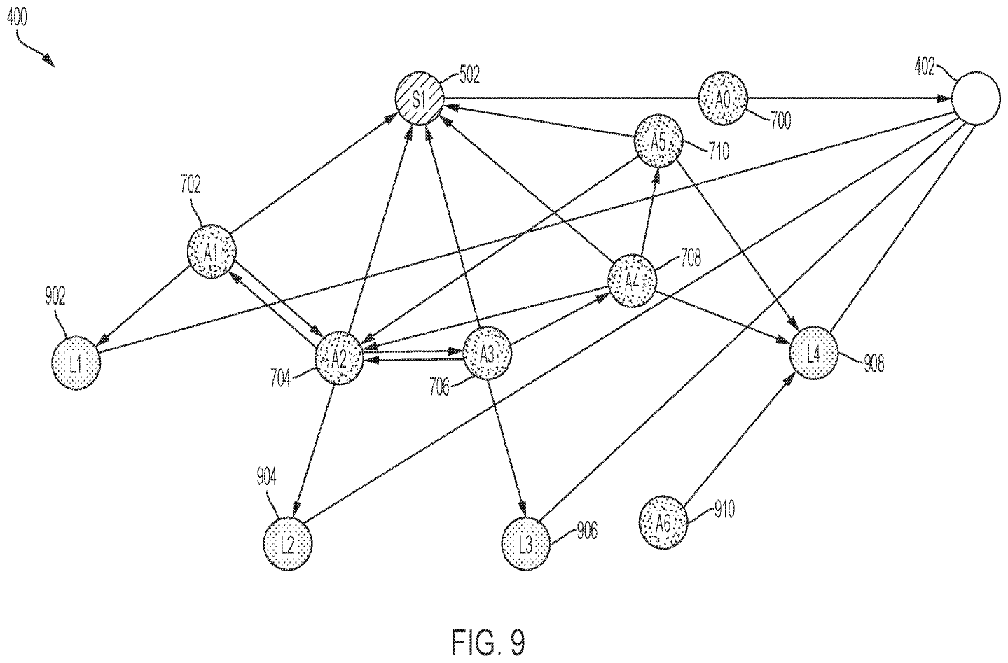

Once the microgrammatical analysis provides connections between the various archetypes defining the text within the medical report 100, FIG. 9 illustrates creating logics nodes within the ARNI system 400 in accordance with an example embodiment. For example, the ARNI system 400 can create one or more ontological logic nodes based on the unstructured data (e.g., text of the medical report 100). These ontological logic nodes build an ephemeral logics graph, where logical inference model(s) are applied to solve syllogisms applied to the text by setting inclusion or exclusion properties on archetypal relationships to the ontological logic nodes. Syllogisms are a form of logical argument that applies deductive reasoning to arrive at a conclusion based on two or more propositions that are asserted or assumed to be true. For example, syllogisms arise when a number of true premises (propositions or statements) validly imply a conclusion, or the main point that the argument aims to get across.

For example, as is shown in the example embodiment analyzing the medical report 100 in FIG. 1, FIG. 9 shows logic node L1 902, logic node L2 904, logic node L3 906, and logic node L4 908. Any requirements or conditions related to the logic node are verified by the ARNI system 400 by solving syllogisms related to the logic node (e.g., setting inclusion or exclusion properties on archetypal relationships). Logic node L1 902, for example, is associated with the ontology “Radiological Service”; logic node L2 904 is associated with the ontology “Anatomy”; logic node L3 906 is associated with the ontology “Spatial”; and logic node L4 908 is associated with the ontology “Views”. In some embodiments, logic nodes can be connected/associated with multiple archetypes, such as logic node L4 that is associated with archetype node A4 708, archetype node A5 710, and archetype node A6 910 (a “value” archetype—in this example: the value “2” fund in the text of the medical report 100).

The ontological logic nodes can be created with any type of characteristic or categorization that provides meaning to the unstructured text to be analyzed by ARNI. For example, ontological logic nodes can be based on, but not limited to: medical service, magnitude, medical device, spatial characteristics, medication, outcome, institution, gender, rationales, administration, administration types, administration forms, date/time, treatment, anatomy, dependency, physiology, age, contrast, causality, payer, either/or conditionals, non-causality, inclusion/exclusion of structure types, region/sub-region analysis, numbered/non-numbered anatomical references, general anatomical references, etc.

One or more types of logic can be employed within the logical inference model(s) that are applied to solve syllogisms based on the unstructured text. For example, the ARNI system 400 can include mathematical logic (e.g., node counting, standard counting, operator/function informed counting, variable range counting, alethic/deontic/temporal/ambiguous/polarity logic, modal logic, etc. In some embodiments, the logical inference model(s) can be a modal graph-based domain specific language model, which can combine induction heuristics with deductive techniques to deduce the content and meaning of language. These techniques can inform the creation of the ontological logic nodes, the logical inference model(s) applied, and/or the requirement logics operations. For example, the logical inference model(s) can implement modal logic (e.g., “it is necessary that” and “it is possible that”), deontic (moral) logic (e.g., “it is obligatory that” and “it is permitted that”), temporal logic (e.g., “it will always be the case that”, “it will be the case that”, “it has always been the case that”, “it was the case that”), doxastic logic (e.g., “xx believes that”, and/or epistemic logic (e.g., “xx knows that”), etc. The unstructured text or data can be analyzed based on the various logical expression types for their necessitation rules, distribution axioms, interaction axioms, etc. to determine symmetries/asymmetries between possible logical conclusions to be drawn from the text or data. The logical inference model(s) may use one or a combination of the logical expression types, such as by determining correspondence between axioms and conditions between different logic types (e.g., modal and temporal logics).

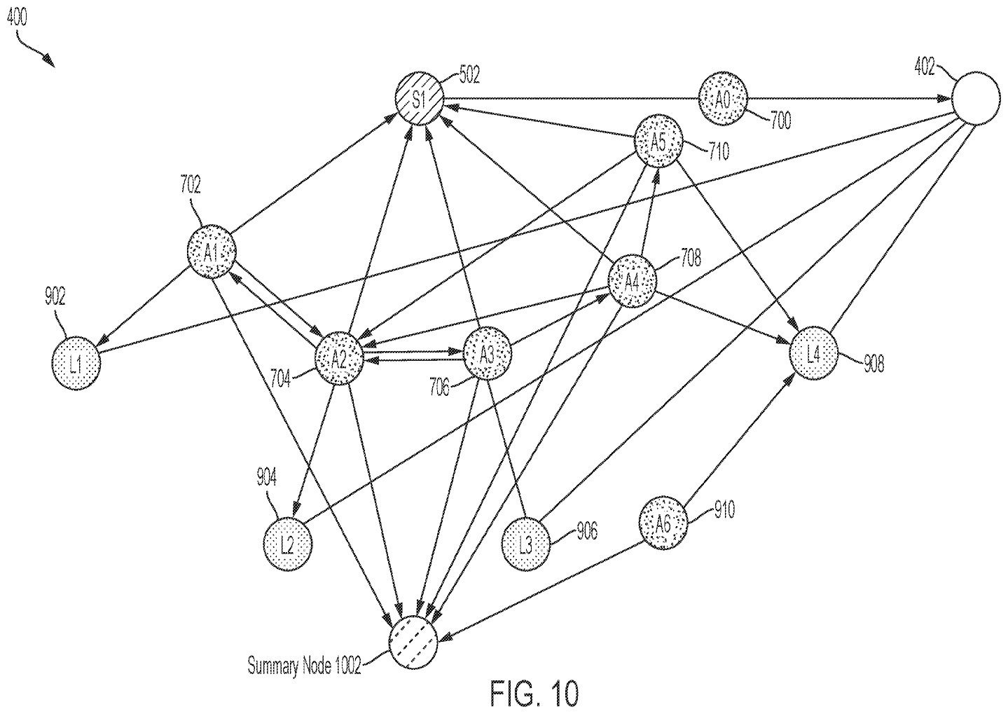

FIG. 10 illustrates the creation of a summary node based on the logics nodes within the ARNI system 400 in accordance with an example embodiment, although any number of summary nodes are contemplated based on the appropriate summarization of the ephemeral knowledge graph. In the example embodiment shown, summary node 1002 is created from the summarization of archetype node A1 702, archetype node A2 704, archetype node A3 706 archetype node A4 708, archetype node A5 710, and archetype node A6 910.

In some embodiments, the summarization process to create summary node 1002 can include using the ephemeral knowledge graph and the ephemeral logic graph to look for concepts that are repeated in the report, placed in positions of relative importance, etc. The ARNI system 400 can analyze the dimensions in which any particular aspect of the particular instance of a concept within the medical report 100 is more specific and isolate the instance, and/or the ARNI system 400 can synthesize a new statement of fact which is more specific in all (or a portion of) variable dimensions than any single instance of the concept within the medical report 100.

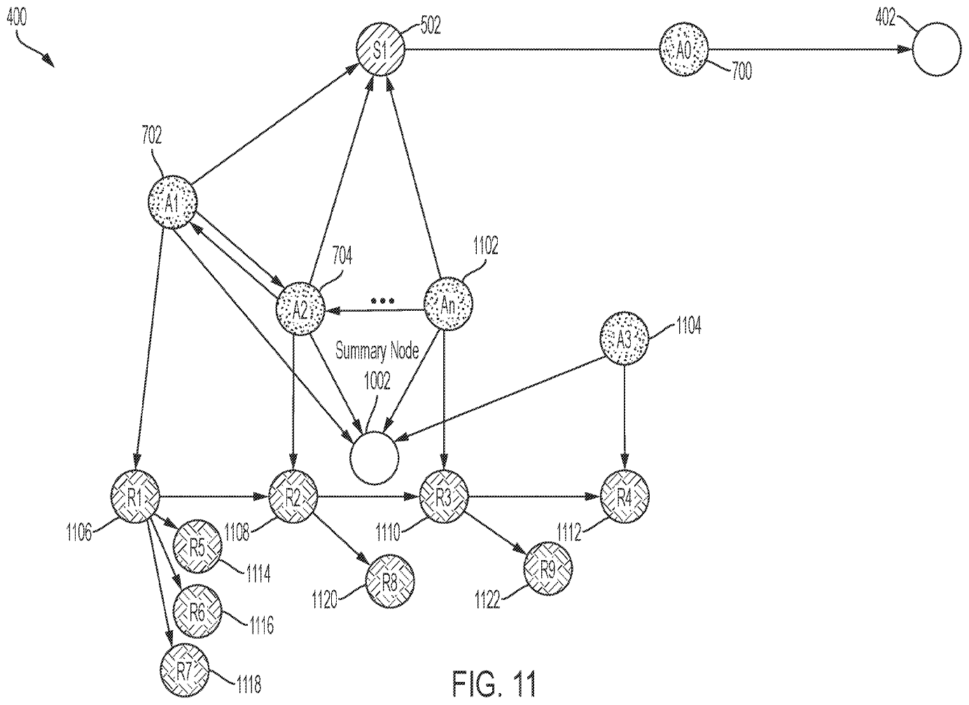

FIG. 11 illustrates a transverse Tree of Operational Requirement (TOOR) to determine requirement satisfaction within the ARNI system 400 in accordance with an example embodiment, although any tree or connected graph structure that can embed mathematical logic, functions, and/or relationships can be implemented.

In some embodiments, the ARNI system 400 can determine valid pathways through a static knowledge graph based on a comparison between nodes of an ephemeral knowledge graph and summary graphs of a report (e.g., medical report 100). Requirement logics operations can be performed on returned transversal pathways, and the ARNI system 400 can recursively run a check for an existence of a coded conclusion for the returned transversal pathways until a coded conclusion has been reached or no transversal pathway matches results of the logics operations.

For example, “x-ray” requirement node R1 1106 is created from archetype node A1 702. The ARNI system 400 can collect all CPT codes, modifiers, ICD-10 codes, MIPS codes, etc. And connect them to the medical report 100. For each recursively run check, the ARNI system 400 can validate that all predicates, operators, functions, etc. requirements are run on the returned transversal pathways. For each path, the ARNI system 400 can check to see if some coded conclusion based on R1 1106 exists as a leaf node in the TOOR system. When either a coded conclusion has been reached or no transversal pathway matches the results of the logical operation, the recursive loop ends on a per branch basis. For example, the branch of requirement node R1 1106 includes “tibia” requirement node R5 1114, “ankle” requirement node R6 1116, and “foot” requirement node R7 1118.

Similarly, “knee” requirement node R2 1108 is created from archetype node A2 704, with a branch including “left” requirement node R8 1120. “Right” requirement node R3 1110 is created from archetype node An 1102, with a branch including “left” requirement node R9 1122; and “logic” requirement node R4 1112 is created from archetype node A3 1104.

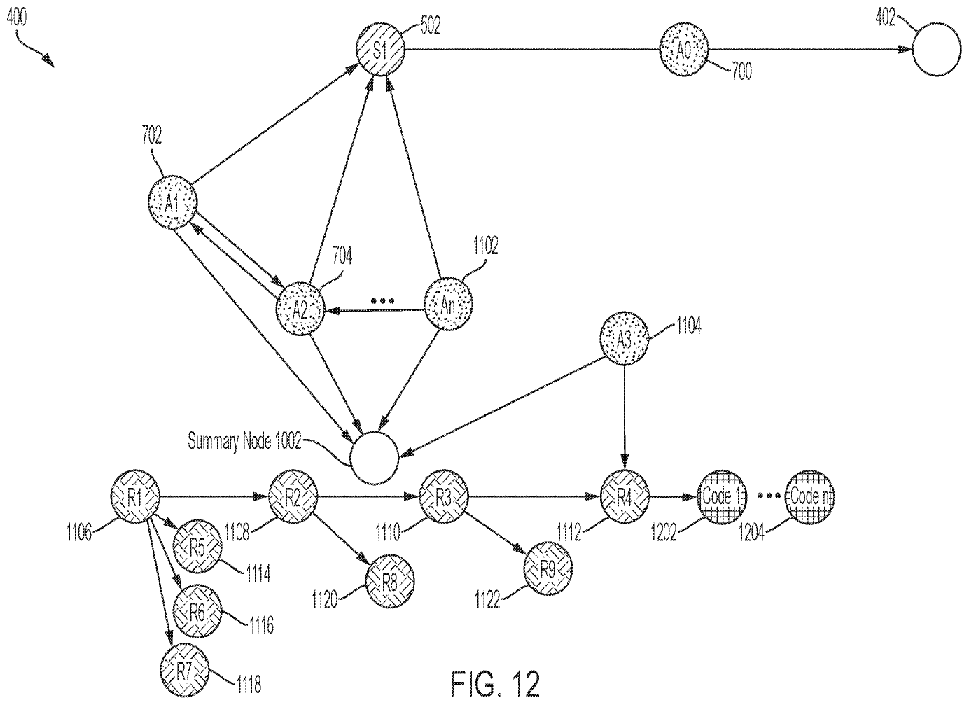

FIG. 12 illustrates code selection within the ARNI system 400 after all the requirement nodes have been created and analyzed, in accordance with an example embodiment. The ARNI system 400 assigns a code (e.g., code 1 1202 . . . code n 1204) to a portion of the text if a coded conclusion has been reached. In some embodiments, one or more codes may apply to overlapping portions of text. The codes can correspond to any type of system of words, letters, figures, or other symbols that provide meaning or summarization to portions of the unstructured text, such as CPT codes, modifiers, ICD-10 codes, MIPS codes, etc. In some embodiments, these code 1 1202 . . . code n 1204 can be encapsulated in a subgraph within the static knowledge graph, and any child codes can be determined and applied if appropriate.

International Classification of Diseases, Tenth Revision (ICD-10) is a system that classifies and codes all diagnoses, symptoms and procedures for claims processing. These codes are used to submit medical invoices for reimbursement from insurance providers.

Many conditions can involve more than one code. For example, a broken bone involves a fracture and pain, each of which are their own code. A medical professional could pick either code, or in some cases, these multiple code combinations have their own “combo code” that represents “the etiology along with its manifestations” or “the diagnosis and the symptoms.” Many times these codes are chosen or combined for a predetermined, stated reason. Other times the reasons are unstated but accepted in the coding community and implemented broadly. In this latter case, data can inform which of the selections is the better and more trusted code.

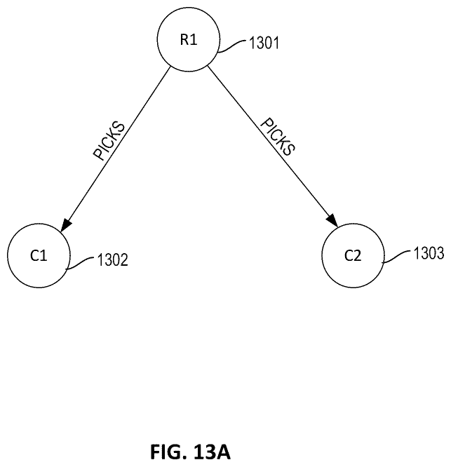

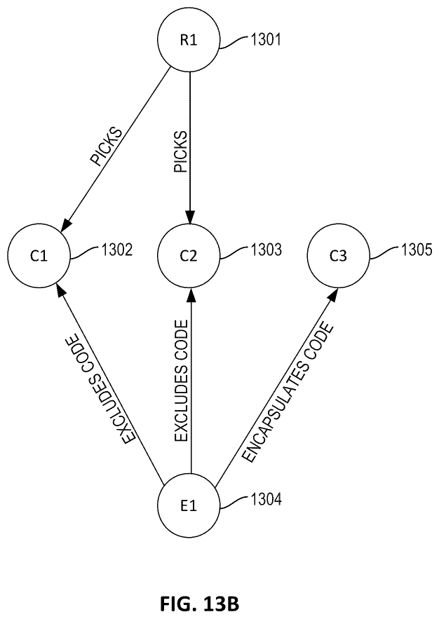

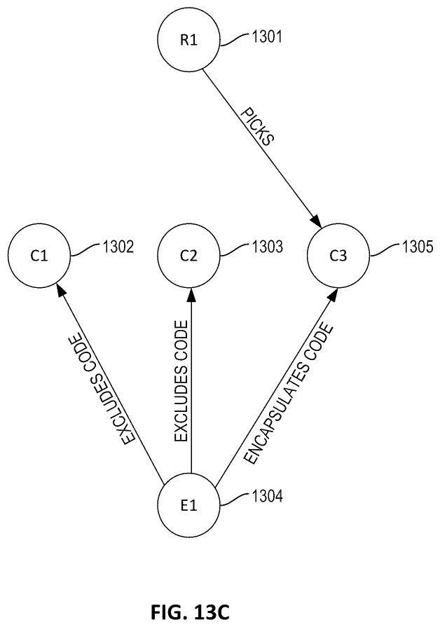

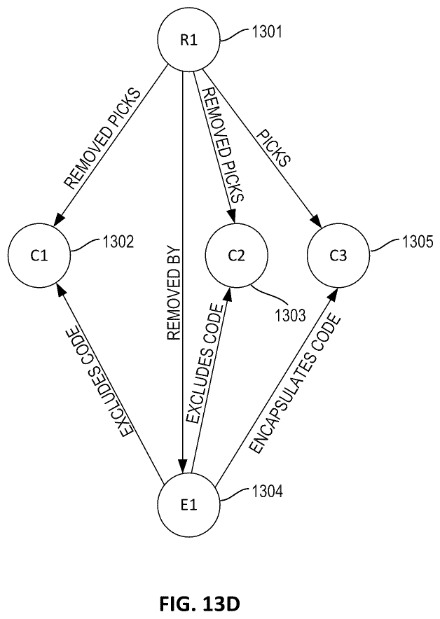

FIGS. 13A-19C illustrate subgraph schema that extends the ARNI subgraph schema to identify the appropriate selection when more than one selection has been identified by ARNI as the appropriate selection. For example, and without limitation, the selection can be a medical code derived from a medical report by the ARNI system described above. The subgraph schema implements a process called encapsulation, which determines which of the selections should stay or be removed based upon logical criteria from ARNI's (the method's) static data and dynamic syntactic analysis of property values stored on the picked selection descriptions. In particular, the selections can be made by, for example, the ARNI system described above. For simplicity's sake, each of these implementations will be referred to as a “method” below. However, each of the below methodologies can be implemented as methods, systems, and computer-readable media.

FIGS. 13A-D illustrate exemplary subgraph schema for selecting one of a plurality of selections according to a total encapsulation methodology. In the total encapsulation methodology, the method selects two possible codes, but where neither are the correct code. Instead, either a third code or a “combo” code is the appropriate code.

As shown in FIG. 13A, the method receives a report 1301 that has been analyzed with the method to extract meaning from its contents. Here, the method selected multiple codes 1302, 1303 that correspond to the report 1301 based on the textual analysis of the report as described above with respect to FIGS. 1-12. Upon determining there are multiple codes with static knowledge graph encapsulation relationships, the method queries a static knowledge graph for encapsulation data describing the correct code to be selected.

As shown in FIG. 13B, the method reads the excludes node 1304 for properties that determine the correct code based on the report 1301. The method retrieves the following properties from the excludes node 1304: encapsulator: C3; EncapsulatorType: CODE; excludes: C1 and C2; mode: total. As shown in FIG. 13C, the method then runs a command to both remove the two excluded codes 1302, 1303 (represented numerically as C1 and C2, respectively), and to select the encapsulated code 1305 (represented numerically as C3). To conclude the operation, the method then writes metadata relationships to reflect the relationship between the encapsulated code 1304 and the report 1301 and also between the excluded codes 1302, 1303 and the report 1301, as shown in FIG. 13D. These metadata relationships can then be used by the method in later iterations to determine the appropriate code based on the meaning extracted from the report 1301.

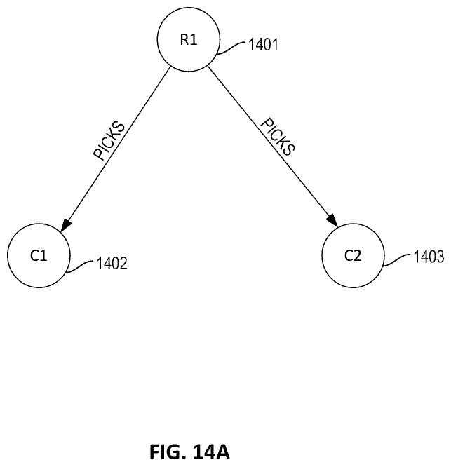

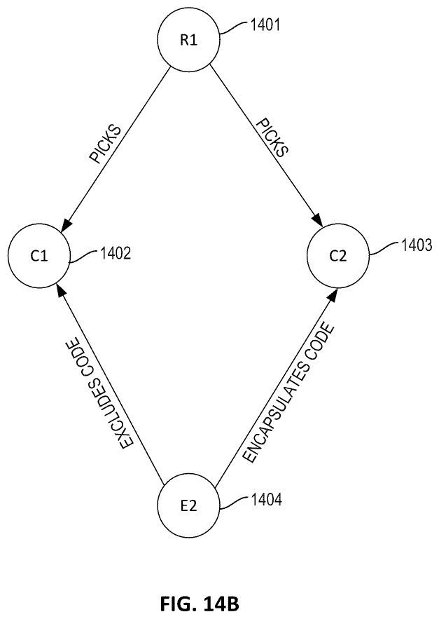

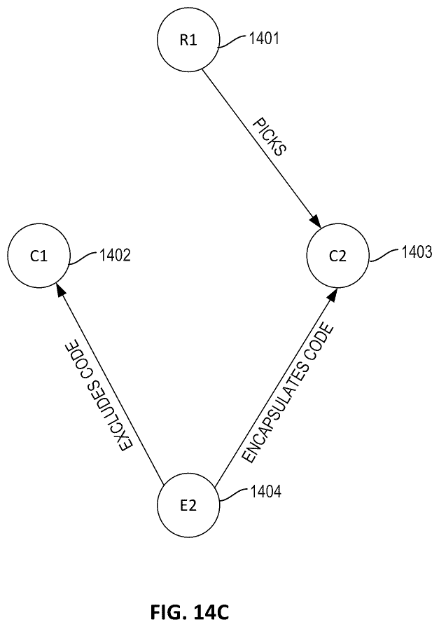

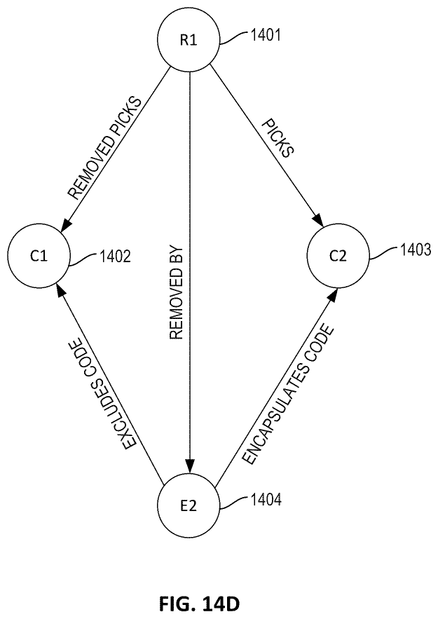

FIGS. 14A-D illustrate exemplary subgraph schema for selecting one of a plurality of selections according to a partial encapsulation methodology. In the partial encapsulation methodology, the method selects two or more codes and, through the encapsulation method, determines which of the plurality of codes is correct.

As shown in FIG. 14A, the method receives a report 1401 that has been analyzed with the method to extract meaning from its contents. Here, the method selected multiple codes 1402, 1403 that correspond to the report 1401 based on the textual analysis of the report as described above with respect to FIGS. 1-13. Upon determining there are multiple codes with static knowledge graph encapsulation relationships, the method queries a static knowledge graph for encapsulation data describing the correct code to be selected.

As shown in FIG. 14B, the method reads the excludes node 1404 for properties that determine the correct code based on the report 1401. The method retrieves the following properties from the excludes node 1404: encapsulator: C2; EncapsulatorType: CODE; excludes: C1; mode: partial. As shown in FIG. 14C, the method then runs a command to both remove the excluded code 1402 (represented numerically as C1), and to select the encapsulated code 1403 (represented numerically as C2). To conclude the operation, the method then writes metadata relationships to reflect the relationship between the encapsulated code 1403 and the report 1401 and also between the excluded code 1402 and the report 1401, as shown in FIG. 14D. These metadata relationships can then be used by the method in later iterations to determine the appropriate code based on the meaning extracted from the report 1401.

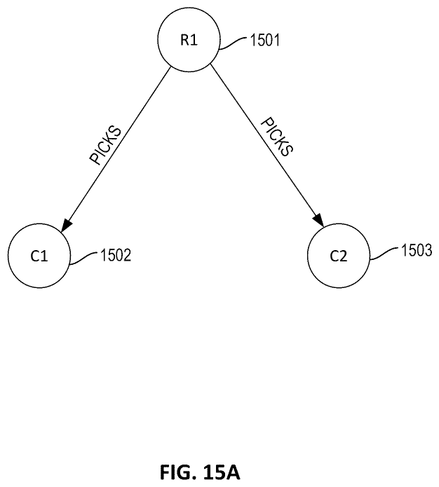

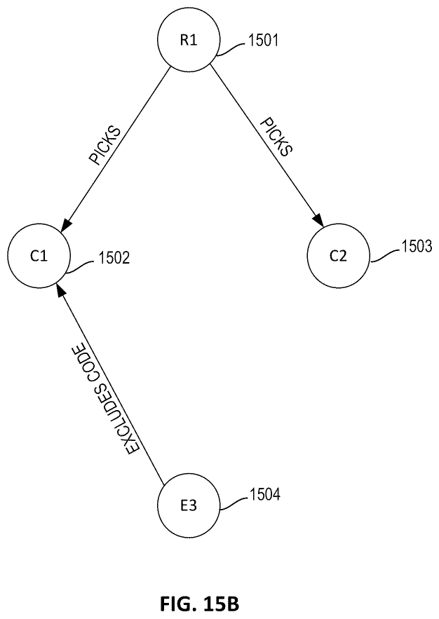

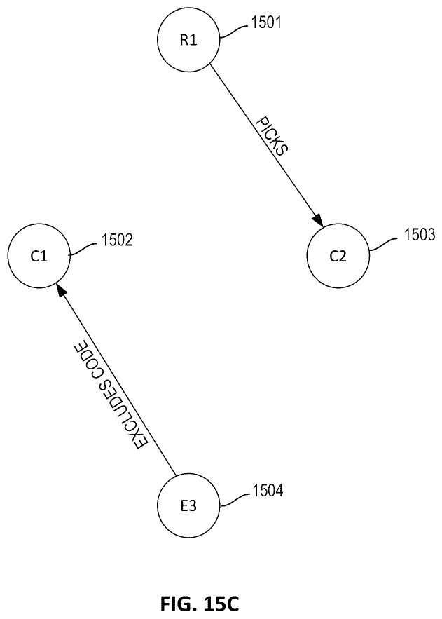

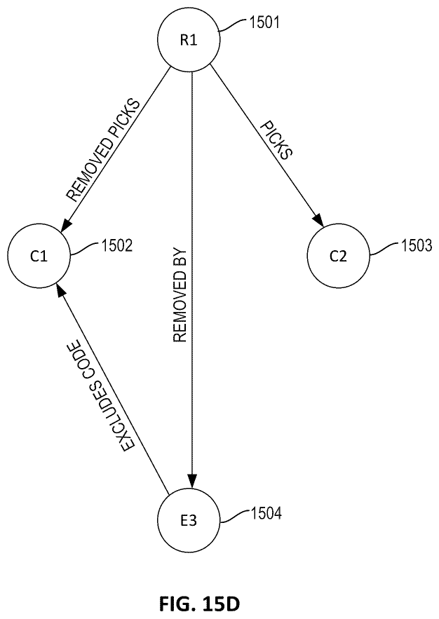

FIGS. 15A-D illustrate exemplary subgraph schema for selecting one of a plurality of selections according to an isolated encapsulation methodology. In the isolated encapsulation methodology, the method selects two possible codes, where one is the correct code. But unlike the partial encapsulation methodology—where the excludes node includes an encapsulation rule—the isolated encapsulation methodology merely retains one of the selections while excluding the others. It does not select one of the selections based on predetermined encapsulation data.

As shown in FIG. 15A, the method receives a report 1501 that has been analyzed with the method to extract meaning from its contents. Here, the method selected multiple codes 1502, 1503 that correspond to the report 1501 based on the textual analysis of the report as described above with respect to FIGS. 1-13. Upon determining there are multiple codes with static knowledge graph encapsulation relationships, the method queries a static knowledge graph for encapsulation data describing the correct code to be selected.

As shown in FIG. 15B, the method reads the excludes node 1504 for properties that determine the correct code based on the report 1501. The method retrieves the following properties from the excludes node 1504: encapsulator: C1; EncapsulatorType: CODE; mode: isolated. As shown in FIG. 15C, the method then runs a command to both remove the excluded code 1502 (represented numerically as C1), and to retain the remaining code, in this case code 1503. To conclude the operation, the method then writes metadata relationships to reflect the relationship between the selected code 1503 and the report 1501 and also between the excluded code 1502 and the report 1501, as shown in FIG. 15D. These metadata relationships can then be used by the method in later iterations to determine the appropriate code based on the meaning extracted from the report 1501.

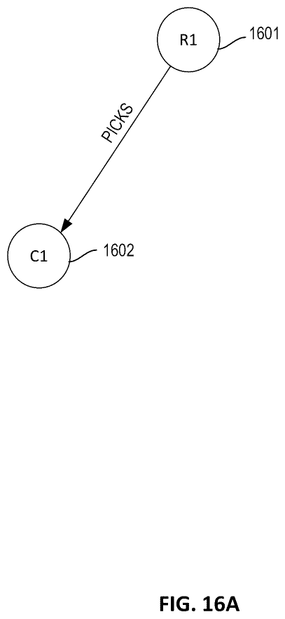

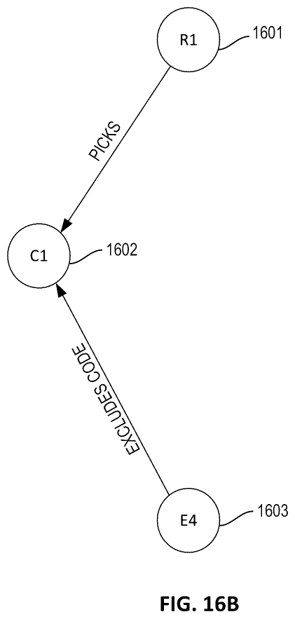

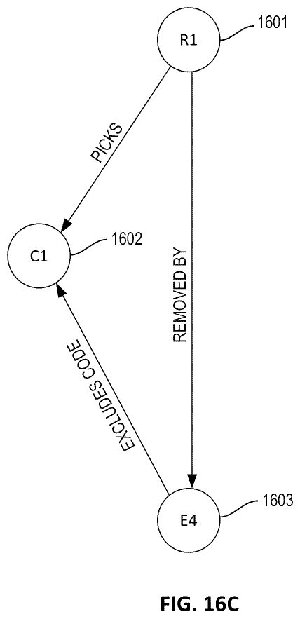

FIGS. 16A-C illustrate exemplary subgraph schema for selecting a selection according to a single isolated encapsulation methodology. In the single isolated encapsulation methodology, the method confirms the single code is the correct selection using similar techniques as described above.

As shown in FIG. 16A, the method receives a report 1601 that has been analyzed with the method to extract meaning from its contents. Here, the method selected a single code 1602 that corresponds to the report 1601 based on the textual analysis of the report as described above with respect to FIGS. 1-13. The method then queries a static knowledge graph for encapsulation data describing the correct code to be selected.

As shown in FIG. 16B, the method reads the excludes node 1603 for properties that determine the correct code based on the report 1601. The method retrieves the following properties from the excludes node 1603: encapsulator: C1; EncapsulatorType: CODE; mode: isolated. As shown in FIG. 16C, the method then runs a command to ensure the isolated code 1602 is the only code that is coded, and writes metadata relationships to reflect the relationship between the selected code 1602 and the report 1601.

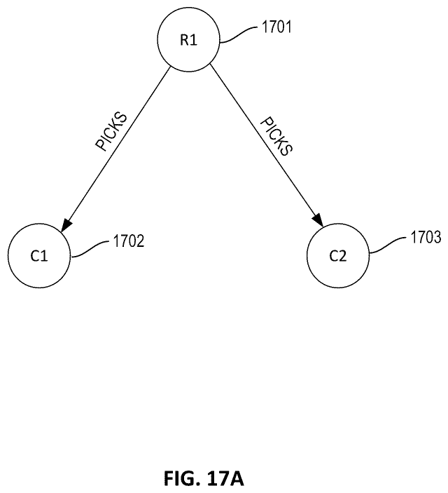

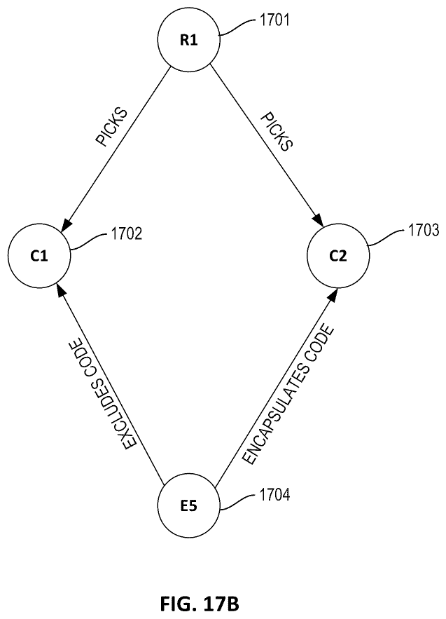

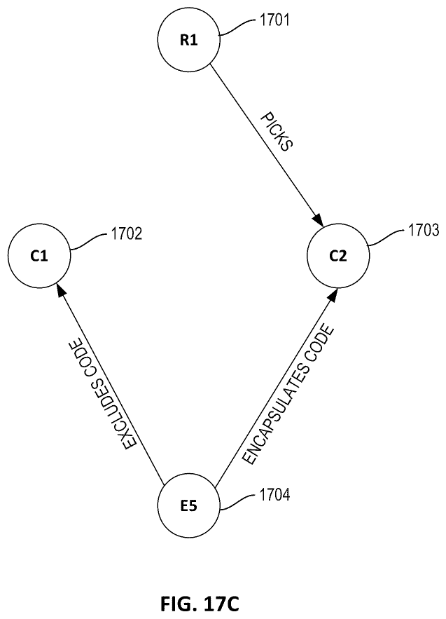

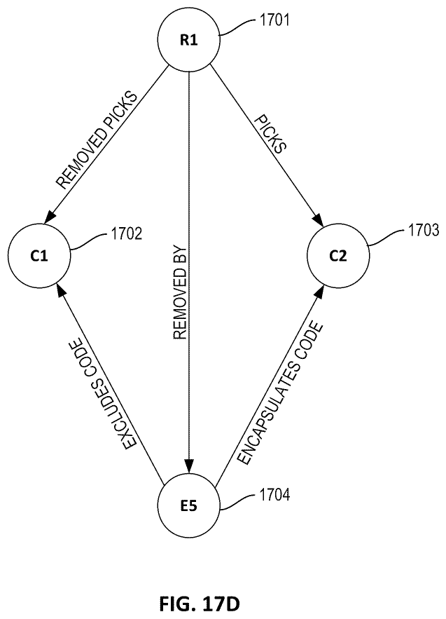

FIGS. 17A-D illustrate exemplary subgraph schema for selecting a selection according to a sibling code encapsulation methodology. In the sibling code encapsulation methodology, the method chooses between two codes whose identification differs from another code by only one place value at the seventh position (e.g., S07.071A and S07.071B).

As shown in FIG. 17A, the method receives a report 1701 that has been analyzed with the method to extract meaning from its contents. Here, the method selected multiple codes 1702, 1703 that correspond to the report 1701 based on the textual analysis of the report as described above with respect to FIGS. 1-13. The method then queries a static knowledge graph for encapsulation data describing the correct code to be selected.

As shown in FIG. 17B, the method reads the excludes node 1704 for properties that determine the correct code based on the report 1701. The method retrieves the following properties from the excludes node 1704: encapsulator: C2; EncapsulatorType: CODE; mode: sibling. As shown in FIG. 17C, the method then runs a command to both remove the excluded code 1702 and to retain the encapsulated code 1703. For example, the method selects the more specific code and encapsulates that code, while removing the less specific sibling's code. Sibling codes are more specific as they proceed alphabetically (e.g., codes ending in B are more specific than the same code ending in A). To conclude the operation, the method then writes metadata relationships to reflect the relationship between the selected code 1703 and the report 1701 and also between the excluded code 1702 and the report 1701, as shown in FIG. 17D. These metadata relationships can then be used by the method in later iterations to determine the appropriate code based on the meaning extracted from the report 1701, or from future selections where siblings are selected alongside one another.

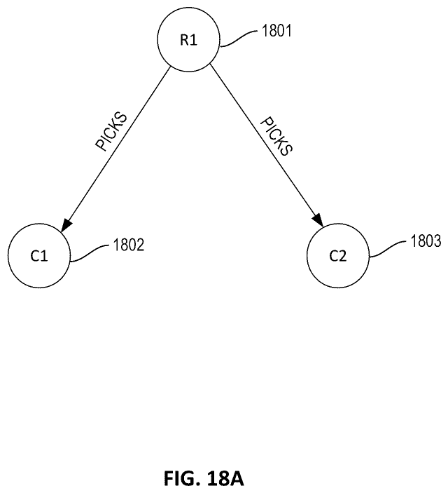

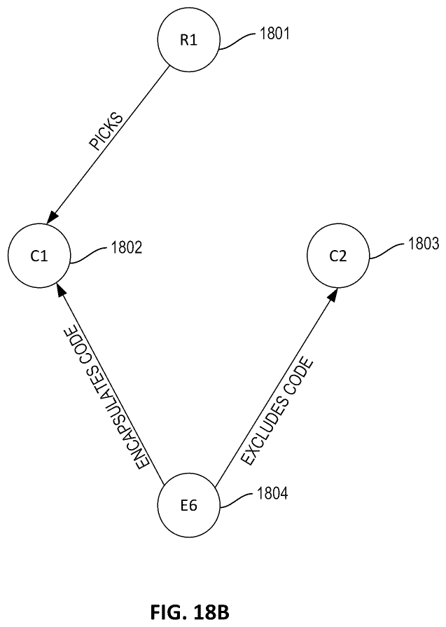

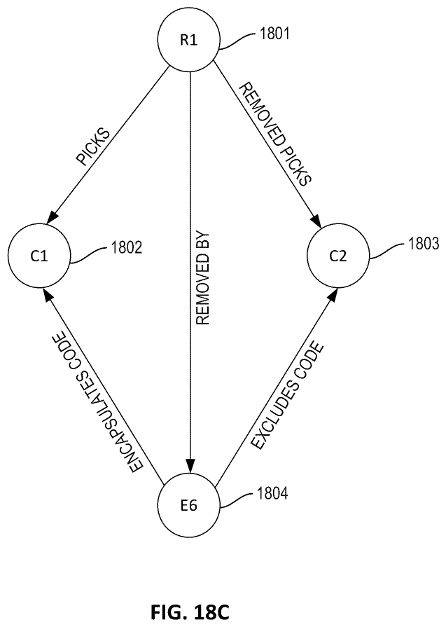

FIGS. 18A-C illustrate exemplary subgraph schema for selecting a selection according to a textual analysis sibling code encapsulation methodology. Although many siblings are easy to differentiate with their final alphanumerical value, other siblings cannot be identified by such simple pattern recognition. In such cases, textual analysis is required to determine if two codes are siblings.

As shown in FIG. 18A, the method receives a report 1801 that has been analyzed with the method to extract meaning from its contents. Here, the method selected multiple codes 1802, 1803 that correspond to the report 1801 based on the textual analysis of the report as described above with respect to FIGS. 1-13. The method can then perform other encapsulation methods to determine the correct code selection. If the other encapsulation methods fail, the method can then perform a textual analysis to determine the existence of sibling codes, and also determine which is the more specific code. For example, the method can read code 1802 and find properties: code: M43.06; text: Spondylolysis-lumbar region. The method can then read code 1803 and find properties: code: M43.0; text: Spondylolysis, site unspecified. Here, code 1802 is more specific because it identifies the site of the spondylolysis. The method can then encapsulate the more specific code 1802 (as shown in FIG. 18B), and exclude the less specific code 1803, and write the metadata relationships as appropriate (as shown in FIG. 18C).

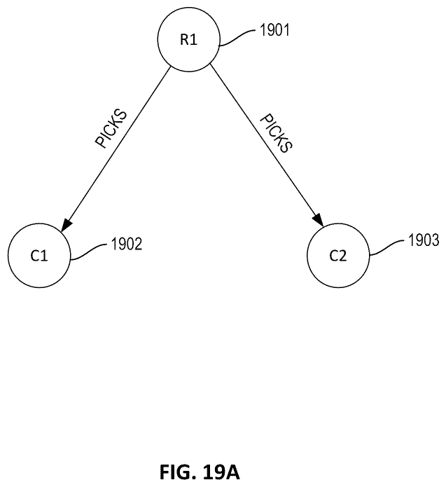

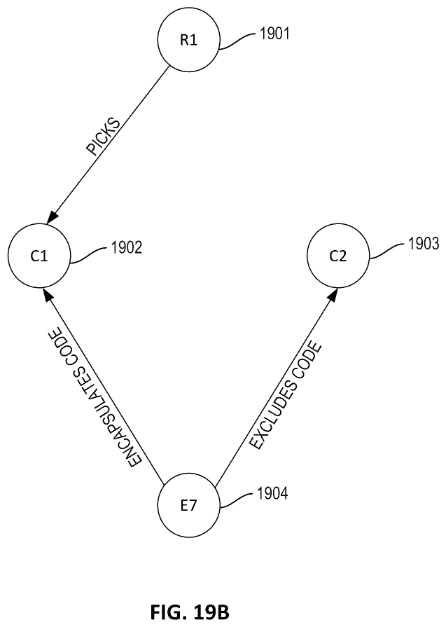

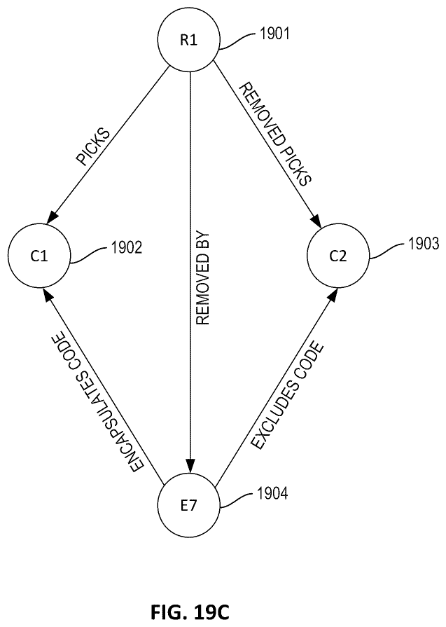

FIGS. 19A-C illustrate exemplary subgraph schema for selecting a selection according to an ad hoc encapsulation methodology. Some codes do not follow specific patterns or rules and, as such, must be textually analyzed in combination with each other to determine the appropriate coding.

As shown in FIG. 19A, the method receives a report 1901 that has been analyzed with the method to extract meaning from its contents. Here, the method selected multiple codes 1902, 1903 that correspond to the report 1901 based on the textual analysis of the report as described above with respect to FIGS. 1-13. The method then queries a static knowledge graph for encapsulation data describing the correct code to be selected.

Once all other encapsulation methods are exhausted, the method performs an ad hoc analysis to determine the appropriate code. Here, the method performs a textual analysis of both codes 1902, 1903 and determines the codes overlap. The method then removes the less severe code and retains the more severe code, as shown in FIG. 19B. The method then writes metadata relationships to capture the graph transformations, as shown in FIG. 19C.

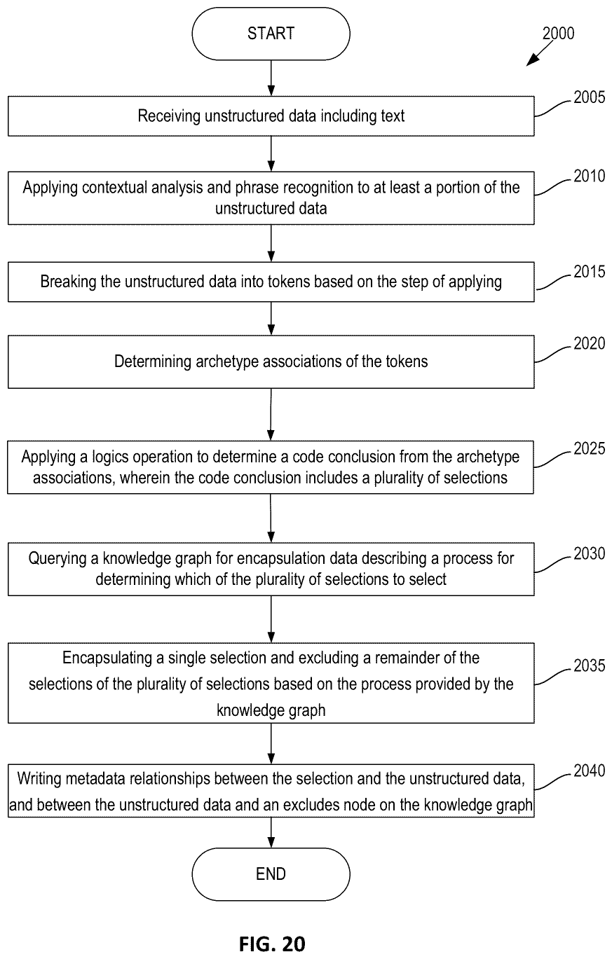

FIG. 20 is a flowchart illustrating a method 2000 for performing encapsulation methods to encapsulate a single selection and exclude all other selections, according to at least some of the present embodiments. As shown, the process 2000 begins and proceeds to step 2005, where unstructured data is received. For example, the unstructured data can include text, images, and/or other representations of language, but in some embodiments, includes at least text. For example, the unstructured textual data can be text within a medical report.

The process 2000 can proceed to step 2010, where the method applies contextual analysis and phrase recognition to at least a portion of the unstructured data. For example, one or more logical inference models can be applied to the unstructured data that combines the induction heuristic model with at least one deductive technique to generate at least one meaning to the at least one or more portions of the unstructured data. The method can use a logical inference model such as the ARNI system described above in more detail.

The process 2000 can proceed to step 2015, where the method 2000 breaks the unstructured data into tokens based on the step of applying. For example, one or more sentences of the unstructured textual data can be broken into one or more tokens and the one or more tokens can be attached to a sentence node within a knowledge graph.

The process 2000 can proceed to step 2020, where the method 2000 determines archetype associations of the tokens. For example, archetypes can be explicitly defined or can be inferred by logical inference model(s). In some embodiments, the archetype can span multiple types of token archetype characteristics, such as unitary or compound. Any other form of archetype association can be implemented, including but not limited to those discussed above with respect to block 312.

The process 2000 can proceed to step 2025, where the method 2000 applies a logics operation to determine a code conclusion from the archetype associations. The code conclusion can include a plurality of selections. For example, the method 2000 can apply a logics operation to determine which medical codes are associated with the text provided in the unstructured data (which can be a medical report).

The process 2000 can proceed to step 2030, where the method 2000 queries a knowledge graph for encapsulation data describing a process for determining which of the plurality of selections to select. For example, the process 2010 can query an excludes node within a knowledge graph and read the properties of the excludes node to determine the encapsulation method to be used to determine the appropriate medical code.

The process 2000 can then proceed to step 2035, where a single selection is encapsulated and a remainder of the selections are excluded based on the process provided by the knowledge graph. For example, in the partial encapsulation method, the process 2000 can encapsulate the appropriate code among the plurality of codes originally picked, and can exclude the remainder of the plurality of codes originally picked.

The process 2000 can then proceed to step 2040, where the process can write metadata relationships between the selection and the unstructured data, and between the unstructured data and an excludes node on the knowledge graph. For example, the process 2000 can write metadata relationships indicating the proper code to select given the unstructured data input into ARNI. Following step 2040, the process ends.

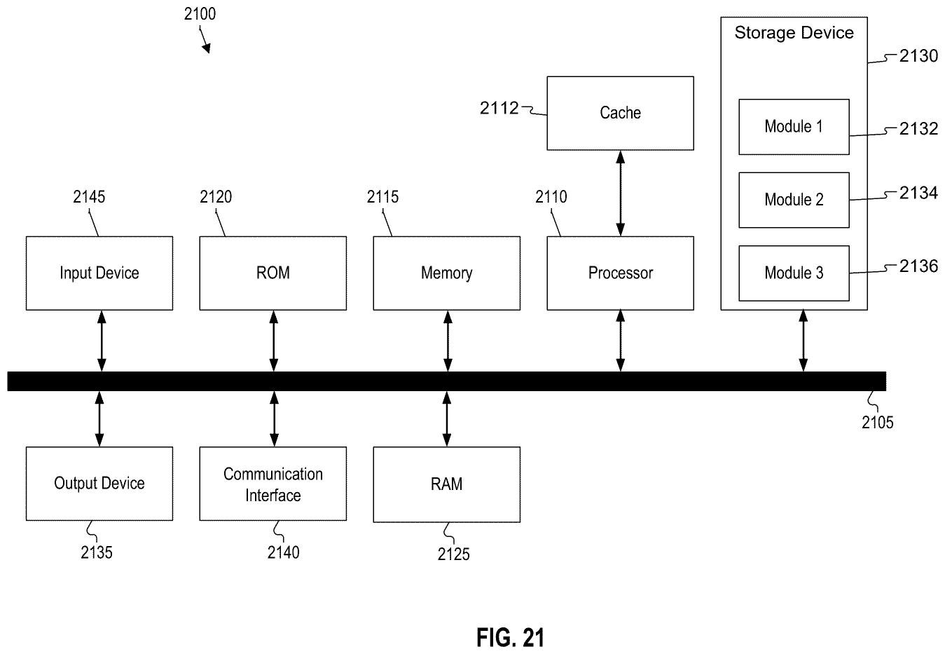

FIG. 21 shows an example of computing system 2100, which can be for example any computing device making up or executing the systems, methods, and instructions stored on computer-readable media as described herein, or any component thereof in which the components of the system are in communication with each other using connection 2105. Connection 2105 can be a physical connection via a bus, or a direct connection into processor 2110, such as in a chipset architecture. Connection 2105 can also be a virtual connection, networked connection, or logical connection.

In some embodiments computing system 2100 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 2100 includes at least one processing unit (CPU or processor) 2110 and connection 2105 that couples various system components including system memory 2115, such as read only memory (ROM) 2120 and random access memory (RAM) 2125 to processor 2110. Computing system 2100 can include a cache of high-speed memory 2112 connected directly with, in close proximity to, or integrated as part of processor 2110.

Processor 2110 can include any general purpose processor and a hardware service or software service, such as services 2132, 2134, and 2136 stored in storage device 2130, configured to control processor 2110 as well as a special-purpose processor where software instructions are incorporated into the actual processor design. Processor 2110 may essentially be a completely self-contained computing system, containing multiple cores or processors, a bus, memory controller, cache, etc. A multi-core processor may be symmetric or asymmetric.

To enable user interaction, computing system 2100 includes an input device 2145, which can represent any number of input mechanisms, such as a microphone for speech, a touch-sensitive screen for gesture or graphical input, keyboard, mouse, motion input, speech, etc. Computing system 2100 can also include output device 2135, which can be one or more of a number of output mechanisms known to those of skill in the art. In some instances, multimodal systems can enable a user to provide multiple types of input/output to communicate with computing system 2100. Computing system 2100 can include communications interface 2140, which can generally govern and manage the user input and system output. There is no restriction on operating on any particular hardware arrangement and therefore the basic features here may easily be substituted for improved hardware or firmware arrangements as they are developed.

Storage device 2130 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 2130 can include software services, servers, services, etc., that when the code that defines such software is executed by the processor 2110, it causes the system to perform a function. In some embodiments, a hardware service that performs a particular function can include the software component stored in a computer-readable medium in connection with the necessary hardware components, such as processor 2110, connection 2105, output device 2135, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per sc.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method of selecting a single selection from multiple selections comprising:
receiving unstructured data including text;
applying contextual analysis and phrase recognition to at least a portion of the unstructured data;
breaking the unstructured data into tokens based on the step of applying;
determining archetype associations of the tokens;
applying a logics operation to determine a code conclusion from the archetype associations, wherein the code conclusion includes a plurality of selections;
querying a knowledge graph for encapsulation data describing a process for determining which of the plurality of selections to select; and
encapsulating a single selection and excluding a remainder of the selections of the plurality of selections based on the process provided by the knowledge graph.

2. The method of claim 1, further comprising writing metadata relationships between the selection and the unstructured data.

3. The method of claim 1, further comprising writing metadata relationships between the unstructured data and an excludes node on the knowledge graph.

4. The method of claim 1, wherein the single selection is not among the plurality of selections, and the excluding excludes each of the plurality of selections.

5. The method of claim 1, wherein the single selection is among the plurality of selections, and the remainder of the selections include all of the plurality of selections except for the single selection.

6. The method of claim 1, wherein the plurality of selections are medical codes that differ only at a final alphanumeric position, and wherein the step of choosing chooses the selection with a highest alphabetical letter as compared to a remainder of the plurality of selections.

7. The method of claim 1, wherein the step of choosing a single selection includes textually analyzing the plurality of selections.

8. A computing apparatus comprising:
a processor; and
a memory storing instructions that, when executed by the processor, configure the apparatus to perform the following steps:
receiving unstructured data including text;
applying contextual analysis and phrase recognition to at least a portion of the unstructured data;
breaking the unstructured data into tokens based on the step of applying;
determining archetype associations of the tokens;
applying a logics operation to determine a code conclusion from the archetype associations, wherein the code conclusion includes a plurality of selections;
querying a knowledge graph for encapsulation data describing a process for determining which of the plurality of selections to select; and
encapsulating a single selection and excluding a remainder of the selections of the plurality of selections based on the process provided by the knowledge graph.

9. The computing apparatus of claim 8, wherein the instructions further configure the apparatus to perform writing metadata relationships between the selection and the unstructured data.

10. The computing apparatus of claim 8, wherein the instructions further configure the apparatus to perform writing metadata relationships between the unstructured data and an excludes node on the knowledge graph.

11. The computing apparatus of claim 8, wherein the single selection is not among the plurality of selections, and the excluding excludes each of the plurality of selections.

12. The computing apparatus of claim 8, wherein the single selection is among the plurality of selections, and the remainder of the selections include all of the plurality of selections except for the single selection.

13. The computing apparatus of claim 8, wherein the plurality of selections are medical codes that differ only at a final alphanumeric position, and wherein the step of choosing chooses the selection with a highest alphabetical letter as compared to a remainder of the plurality of selections.

14. The computing apparatus of claim 8, wherein the step of choosing a single selection includes textually analyzing the plurality of selections.

15. A non-transitory computer-readable storage medium, the computer-readable storage medium including instructions that when executed by a computer, cause the computer to perform the following steps:
receiving unstructured data including text;
applying contextual analysis and phrase recognition to at least a portion of the unstructured data;
breaking the unstructured data into tokens based on the step of applying;
determining archetype associations of the tokens;
applying a logics operation to determine a code conclusion from the archetype associations, wherein the code conclusion includes a plurality of selections;
querying a knowledge graph for encapsulation data describing a process for determining which of the plurality of selections to select; and
encapsulating a single selection and excluding a remainder of the selections of the plurality of selections based on the process provided by the knowledge graph.

16. The non-transitory computer-readable storage medium of claim 15, wherein the instructions further configure the computer to perform writing metadata relationships between the selection and the unstructured data.

17. The non-transitory computer-readable storage medium of claim 15, wherein the instructions further configure the computer to perform writing metadata relationships between the unstructured data and an excludes node on the knowledge graph.

18. The non-transitory computer-readable storage medium of claim 15, wherein the single selection is not among the plurality of selections, and the excluding excludes each of the plurality of selections.

19. The non-transitory computer-readable storage medium of claim 15, wherein the plurality of selections are medical codes that differ only at a final alphanumeric position, and wherein the step of choosing chooses the selection with a highest alphabetical letter as compared to a remainder of the plurality of selections.

20. The non-transitory computer-readable storage medium of claim 15, wherein the step of choosing a single selection includes textually analyzing the plurality of selections.
